(19) United States
(12) Patent Application Publication
(10) Pub. No.: US 2022/0036867 A1
(43) Pub. Date: Feb. 3, 2022

(54) Entertainment System

(71) Applicant: Josh Jones, Slidell, LA (US)

(72) Inventor: Josh Jones, Slidell, LA (US)

(21) Appl. No.: 17/201,752

(22) Filed: Mar. 15, 2021

Related U.S. Application Data
(60) Provisional application No. 63/058,739, filed on Jul. 30, 2020.

(51) Int. Cl. G10H 1/36; G10H 1/00; G10H 1/32

(52) U.S. Cl. CPC G10H 1/361; G10H 1/0083; G10H 1/0016; G10H 2240/211; G10H 2220/011; G10H 2220/076; G10H 1/32

(57) ABSTRACT

This present invention relates to a stringed musical instrument with an integrated touch video screen allowing a user to play the instrument while singing along with a variety of pre-recorded songs. The video screen displays the words and other information of a user selected song. More specifically, the stringed musical instrument has built in karaoke components and the strings of the instrument can be strummed by the user to play a melody, or the user may mimic playing the instrument strings, wherein the sounds emitted from the strings can be muted.

### CROSS-REFERENCE TO RELATED APPLICATION

The present application claims priority to, and the benefit of, U.S. Provisional Application No. 63/058,739, which was filed on Jul. 30, 2020 and is incorporated herein by reference in its entirety.

### FIELD OF THE INVENTION

The present invention relates generally to the field of musical instruments. More specifically, the present invention relates to a guitar that can play prerecorded music along with the song subtitles that are visible to the user. The novel guitar features a karaoke type system in the base, a video screen attached to the neck of the guitar, a power supplying jack, one or more control knobs, strings, and other components. An individual may view the video screen displaying the words of prerecorded songs, and may play along on the guitar. Additionally, the user may prefer to mute or disable sound emissions from the guitar strings, and may simply mimic playing guitar strings while a song is playing on the karaoke system. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, karaoke entertainment systems have become a trend in the market. People from every age group love to explore their singing passion at home, bars, restaurants or parties. A karaoke system is a device that plays recorded tracks without vocals. A performer sings into a microphone while reading subtitles synchronized with the timing of the music played by the karaoke system. A variety of karaoke equipment types are designed and are developed to meet the requirements of a broad range of karaoke fans.

Currently, for karaoke lovers, there is not a way to sync a guitar up with a karaoke system. While learning to play and hold the guitar, and while singing to the words of a song, people may desire to have an ideal arrangement such that people can easily view the words. Usually, different types of guitars, such as acoustic, electric, bass and others, are available for individuals. Each of these various types of guitar comprise a basic structure having a base or body, a neck portion extending outwardly from the base or body, a plurality of strings, a head, a tuning mechanism, etc. However, conventional guitars do not include any mechanism to incorporate a karaoke like system into the guitar, or to use a karaoke like system in combination with the guitar so as to maintain synchronous involvement of the guitar and the karaoke system.

Further, people who want to sing while playing a guitar must set up additional equipment, such as a microphone, amplifiers or speakers and other equipment, while setting up for the musical set. Even if a single piece of equipment of this set up, such as a microphone, speaker, etc. is missing, the complete set up loses its full capabilities during a performance. Further, buying all the above-referenced equipment separately is expensive for the individual, and not everyone can afford the total set up cost.

Therefore, there exists a long felt need in the art for an improved entertainment system comprising both a guitar and a karaoke system. More specifically, there is also a long felt need in the art for a guitar which incorporates a karaoke system into its structure, and that does not require a separate karaoke system. Additionally, there is a long felt need in the art for a guitar which incorporates the necessary equipment that may be required for singing songs while playing the guitar, and that eliminates the need to carry and set up multiple pieces of equipment to play a guitar and sing a song simultaneously. Furthermore, there is a long felt need in the art for a guitar having a built-in karaoke system that is relatively light-weight, portable and easy to set up. Finally, there is a long felt need in the art for a combination guitar and karaoke system that is relatively inexpensive to manufacture, and both safe and easy to use.

The subject matter disclosed and claimed herein, in one embodiment thereof, comprises a guitar having built-in karaoke components, thereby allowing a user to play the guitar while singing the lyrics to a song along with the prerecorded music. The combination entertainment system includes a relatively small video screen that is attached to the head of the guitar to display subtitles of a song selected by the user to sing. The song itself is prerecorded in an internal memory of a processor contained within the guitar, wherein the song and the subtitles for the lyrics may be retrieved from the memory of the device. A control panel is also provided to control the operation of the various components of the combination karaoke and guitar system.

In this manner, the novel entertainment system of the present invention accomplishes all of the forgoing objectives, and provides a relatively easy to use, convenient and cost-effective solution to combining the features of a karaoke system with those of a guitar. The entertainment system of the present invention is also user friendly, inasmuch as it is less expensive and does not require that the user put forth effort into setting up a complete karaoke system, or having to purchase both a guitar and a karaoke system separately.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a guitar/karaoke combination entertainment system that allows a user to play the guitar while the karaoke system displays the lyrics to the song being played so that the user or others have the ability to sing in tune with prerecorded songs. The combination entertainment system includes a relatively small video screen that is attached to the head of the guitar to display subtitles or lyrics of a song currently being selected by the user. The songs are prerecorded and stored in an internal memory of the processor contained within the guitar, wherein the subtitles are easily retrieved from the memory. A control panel is also provided to control the operations of the various components of the combined entertainment system.

In a further embodiment of the present invention, a karaoke guitar that allows a user to play the guitar while singing along to prerecorded songs is disclosed. The karaoke guitar includes a plurality of strings which are strummed to play a melody, one or more built-in speakers and a relatively small video screen attached to the head of the guitar to display subtitles of a song currently selected by the user. The display may also provide other messaging, such as the name of the performer, bibliographic information of the song, and trivia questions related to the song, such as where the song was recorded, famous performances of the song, etc. The karaoke guitar is also capable of functioning in two separate modes. In the first mode, the user may strum the guitar strings to play a melody and the melody comes out of the built-in speakers. In contrast, in the second mode, the user may also strum the guitar strings but the sound emanating from the strings is muted and the music of the song being played on the video screen is emanated through the built in speakers. The individual modes are selected via a control panel located on a surface of the karaoke guitar so that the controls are easily accessible by the individual during the performance.

In a further embodiment of the present invention, a novel guitar that allows a user to view lyrics of a song and to sing the song while playing the guitar is disclosed. The novel guitar is comprised of a guitar having a tiltable video screen that is attached at the end of the head of the guitar. The tiltable video screen is configured to wirelessly connect to an electronic device, such as a smart phone displaying the lyrics of the song being played can also be displayed on a separate TV screen, so others in the audience may participate and sing along if they aren't able to see the small screen on the guitar.

In yet a further embodiment of the present invention, a novel musical instrument such as a guitar is disclosed, and comprises an internal memory to store karaoke music. The musical instrument includes an integrated video screen to display lyrics of the stored karaoke music, thereby allowing the prerecorded song to be selected using a control panel or a touch-based video screen. The musical instrument also includes a plurality of speakers to emit either the sounds created by the strumming of the guitar or the song being played on the video screen. The guitar further comprises an integrated microphone that can be used to sing along while playing the musical instrument, wherein the musical instrument can be powered using alternating current (AC) or direct current (DC). As used herein, the term musical instruments includes, without limitation, a guitar, bass, banjo, lute, ukulele, mandolin, etc.

In still a further embodiment of the present invention, a novel musical instrument is disclosed that includes karaoke components placed in the base or housing of the musical instrument. More specifically, a video screen is provided to display lyrics of prerecorded songs, and a control panel is used to select a mode. In the first mode, the strings of the musical instrument are strummed to play a melody and the sound is amplified through the built in speakers. In the second mode, the strings or sound made by the strumming of the strings is muted and the music displayed on the video screen is played by the built-in speakers. A control panel is present on the external surface or housing of the base of the musical instrument for controlling the various components and allowing the user to select between the first and second modes.

In another embodiment of the present invention, a method of operating a combination musical instrument and karaoke system is disclosed. The method comprises the steps of initially selecting a mode of operation of the instrument, wherein the mode is chosen from a first mode in which the strings are strummed to play a melody and the sound is distributed through the built-in speakers of the instrument, or a second mode in which the strings are muted, and the music of the karaoke song displayed on the video screen is played by the built in speakers and the user mimics/lip sync the song played by the instrument.

The musical instrument of the present invention is advantageous because all the karaoke components are built within the body or housing of the musical instrument, thereby allowing a user to play the instrument while singing along with a variety of prerecorded songs. An integrated video screen displays the lyrics of the song and offers the option to mimic strumming of the strings or mute the strings altogether. In addition, the display can also be used to show the finger positions on the strings and neck of the musical instrument to further enhance the simulation and engagement of the instrument by the user.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the combination musical instrument and karaoke system of the present invention in accordance with the disclosed specification;

FIG. 2 illustrates a block diagram that shows the various components of the combination musical instrument and karaoke system of the present invention in accordance with the disclosed specification;

FIG. 3 illustrates a perspective view of a user playing one potential embodiment of the combination musical instrument and karaoke system of the present invention in accordance with the disclosed specification;

FIG. 4 illustrates a perspective view of one potential embodiment of the combination musical instrument and karaoke system of the present invention in accordance with the disclosed specification, wherein the combination musical instrument and karaoke system is in wireless communication with a remote device; and

FIG. 5 illustrates a side perspective view of one potential embodiment of the combination musical instrument and karaoke system of the present invention in accordance with the disclosed specification.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a combination guitar and karaoke system. More specifically, there is also a long felt need in the art for a guitar which incorporates a karaoke system into its structure, and that does not require a separate karaoke system. Additionally, there is a long felt need in the art for a guitar which incorporates the necessary components for singing songs while playing the guitar, and that eliminates the need to carry and set up multiple pieces of equipment to play a guitar and sing a song simultaneously. Furthermore, there is a long felt need in the art for a guitar having a built in karaoke system that is relatively light-weight, portable and easy to set up.

The present invention, in one exemplary embodiment, is a guitar having built in karaoke components that allow a user to play the guitar while singing in tune with prerecorded songs the lyrics of which appear on a screen attached to the guitar. More specifically, the novel guitar comprises a relatively small video screen that is attached to the head of the guitar to display subtitles of a song currently selected by the user. The song is prerecorded and stored in an internal memory of the processor, and the song and its lyrical subtitles are retrievable from the memory. A control panel is used to control the operations of the components of the guitar and the karaoke system. In addition to a guitar, other string-based instruments may also be used as the musical instrument referred to herein including, without limitation, a bass, lute, banjo, ukulele, mandolin, etc.

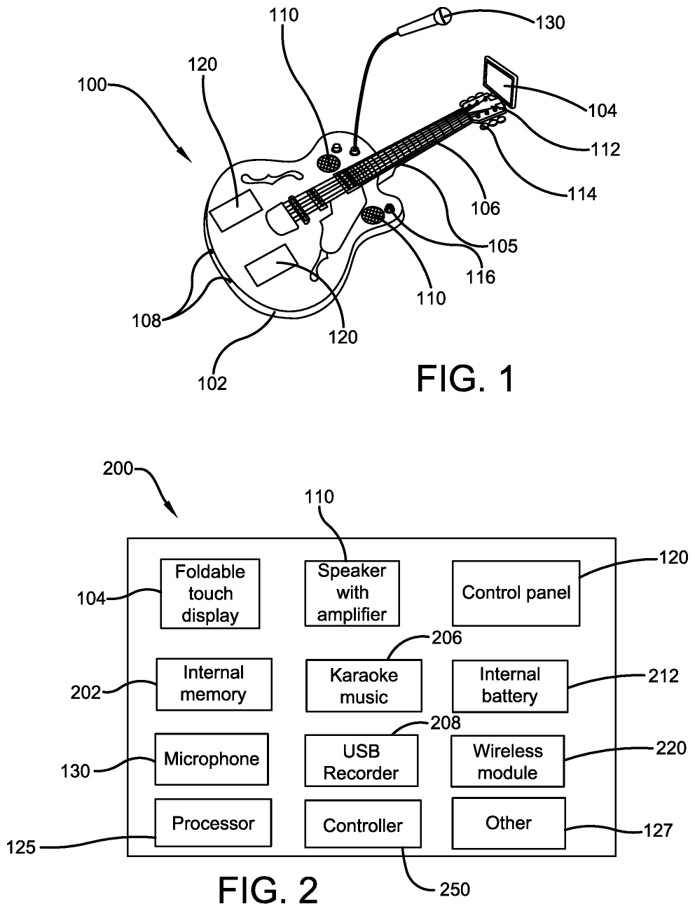

Referring initially to the drawings, FIG. 1 illustrates a perspective view of one potential embodiment of the combination musical instrument and karaoke system 100 of the present invention in accordance with the disclosed specification. The combination musical instrument and karaoke system 100 is generally comprised of a musical instrument 101 and a karaoke machine 103. In this particular embodiment, the musical instrument 101 is a guitar, but it can also be any other suitable stringed instrument including, without limitation, a bass, lute, banjo, ukulele, mandolin, cello, violin, fiddle, etc. The combination musical instrument and karaoke system 100 can also be powered by alternating current (AC) or direct current (DC).

The karaoke machine 103 is comprised of a touch video screen 104 positioned at the head 112 of the instrument 101, which displays the lyrics of a pre-recorded song along with the subtitles or lyrics, which may be displayed in various languages. Nonetheless, the screen 104 may also be positioned along the neck of the instrument 101 and may display other information, such as finger positions on the strings, bibliographic details of the song, trivia or any other information that may enhance the system 100 of the present invention. Other components of the karaoke machine 103 may be positioned in the base or housing 102, which provides sufficient space and electrical connections between the various components. The base or housing 102 further comprises a control panel 120 to control the operation of the various components of the system 100, as described more fully below.

The musical instrument 101 further comprises a plurality of strings 106, which can be used to play the instrument 101 in a manner similar to a conventional guitar, bass, banjo, lute, ukulele, mandolin or the like. Additionally, the control panel 120 can be used to change the mode of operation of the strings 106 so that the same can be, for example, made non-operational or non-sound emitting, such that the instrument can also be used for simulating a performance without any sound being emitted from the strings .

The system 100 may also comprise one or more ¼″ solder type jacks 108 to connect the system 100 to another device, such as a speaker. Additionally, in a preferred embodiment, the system 100 has two built-in speakers 110 to emit the sound of the video being displayed on the video screen 104, as well as the sound caused by the strings 106 being strummed when in an operational or sound emitting mode. The control panel 120 is electrically connected to all the components of the system 100 to send instruction signals to, and otherwise control, the operations of the components. As previously stated, the various components of the karaoke machine 103 (with the exception of the screen 104) may be housed within the base 102, and may be accessed by opening the base or housing 102 using nuts or other fasteners 116 depicted in FIG. 1.

The placement of the touch video screen 104 on the head or neck 112 of the instrument 101 enables an individual to easily view the screen 104 and read the lyrics/subtitles displayed on the screen 104 while playing the instrument 101. The touch screen 104 is preferably both rotatable and tiltable via a rotatable hinge positioned along the head 112, such that the screen 104 can be rotated and/or tilted in any direction to suit user need and/or preference, and to make for more convenient transportation and storage. The video screen 104 can be of any shape, size and/or configuration, and may have a touch or a non-touch surface. The video screen 104 can be controlled using the control panel 120, but may also be in wireless communication with, and controlled by, a remote electronic device, as explained more fully below.

As previously stated, the system 100 is capable of being powered by AC or DC power, and may come in a variety of different types, sizes and colors. The tuning knobs 114 can be used to tune the strings 106 when the musical instrument 101 is being played, and a removable microphone 130 is connected to the musical instrument 101 for the user to utilize while using the system 100 to perform.

FIG. 2 illustrates a block diagram 200 that shows the various components of the combination musical instrument and karaoke system 100 of the present invention in accordance with the disclosed specification. More specifically, the system 100 also comprises an internal memory 202 to store a plurality of lyrics, songs, and any other information that may be preferable to include in the system 100 and that can be selected by the user to show on the video screen 104. The speakers 110 may have integrated amplifiers to produce a quality and amplified sound for the listeners. The system 100 may further comprise a removably attached microphone 130 that can be used by the user for live singing, or that can be removed from the musical instrument 100 if not needed by the user. In one embodiment, the system 100 has an internal battery 212 which can be used to power the system 100 including, without limitation, the video display 104.

In one embodiment, the system 100 may further comprise a wireless communication module 220 for wireless communication with a remote device through, for example, Wi-Fi/Bluetooth SoC. Each of the various components of the system 100 can be controlled by the user through the use of the control panel 120, which may be a touch panel or may have physical control buttons. A controller/processor 250/127 may also be present in the form of an integrated circuit (IC) in a PCB within the base 102 to control the operations of the controller/processor 250/127.

The system 100 may further comprise a shoulder strap 301 which can be connected to the instrument 101 near both of the head and base of the instrument 101, and may be used to support the system 100 on a user's body. In a preferred embodiment, the system 100 further comprises a USB recorder 208 to record the songs and the sounds being played, and an optional camera may also be included to capture the audience and other performers in real time.

Additionally, depending on the design of the system 100, other components 127 can also be added as needed such as, but not limited to, one or more of a separate woofer, tweeter, a device to record the performance, lighting such as LED or “disco” type lights and the like. Each of the additional components 127 may be in wireless communication with one another and/or the controller 250, 120.

As previously stated, the system 100 has different modes of operation. For example, the first or sound-emitting mode enables the user to play the melodies and notes by strumming the strings of the musical instrument 100. By contrast, in a second or non-sound-emitting mode, the user may still strum the strings on the instrument, but the sound of the same can be muted and replaced with just the sound of the karaoke song and/or the user's voice being emitted from the speakers of the system 100 (i.e., while the user mimics playing the instrument). The different modes of operation of the system 100 can be controlled by the user via the control panel 120.

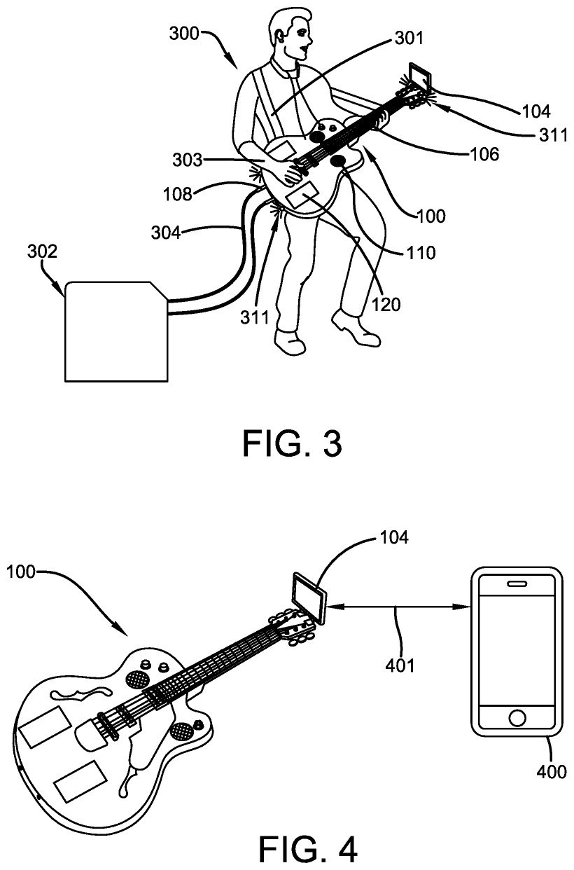

FIG. 3 illustrates a perspective view of a user 300 playing one potential embodiment of the combination musical instrument and karaoke system 100 of the present invention in accordance with the disclosed specification. As shown, the system 100 is hung around the shoulder of the user 300 via a strap 301. The hanging strap 301 enables the user 300 to comfortably support the system 100 while using the same to perform, and also enables the user 300 to easily transport the system 100 from one place to another. The user 300 can use the system 100 similar to a conventional guitar by strumming the strings 106 with the user's hands 303, while also singing along with the karaoke song on the video screen 104. The system 100 may further comprise a plurality of LED lights 311 distributed around the system 100 to enhance the user's performance and the audience's experience. Furthermore, the plurality of lights 311 may be synched with the music to further enhance the user and audience's experience.

Additionally, the system 100 can be connected to an external speaker 302 through wires 304 and jacks 108. Alternatively, a wireless connection may be established between the system 100 and the external speakers 302 using known wireless technologies such as, but not limited to, Bluetooth, RFID, NFC, etc. The control panel 120 can be used to easily change the mode, sound and other settings of the system 100 by the user 300 with his or her hand 303.

As the user is playing the instrument 101, the video screen 104 displays the karaoke song after retrieving the same from the internal memory or through an electronic device in wireless communication with the system 100. It should be appreciated that the video screen 104 is electronically connected to the memory and other electronic components of the system 100. In one mode of operation, the user 300 can strum the strings 106 of the instrument to play a melody that can be heard by both the user and the audience. Alternatively, the instrument 101 itself can be placed on mute, and the speakers 110 will emit the sound of only the karaoke song. In either event, the sound may be emitted through the speaker 302.

FIG. 4 illustrates a perspective view of one potential embodiment of the combination musical instrument and karaoke system 100 of the present invention in accordance with the disclosed specification, wherein the combination musical instrument and karaoke system 101 is in wireless communication with a remote device 400. More specifically, the system 100 may be in wireless communication with an electronic device such as a smartphone 400 via a wireless communication channel 401. The wireless communication channel may be Bluetooth, Wi-Fi, RFID, NFC or any other suitable wireless technology known on the art. Once the system 100 is paired or connected to the mobile device 400, the user may send the karaoke songs stored on the mobile device 400 to the system 100 in order to display the karaoke songs and lyrics on the video screen 104 of the system 100. In this manner, the user 300 can easily view the songs displayed on the screen 104, while playing the instrument 101 along with the same. The wireless connection 401 can also be used to provide the lyrics to members of the audience so that they can enjoy the session and/or sing along to the performance.

In a further embodiment of the system, a corresponding software application for the system 100 may be downloaded and installed on the mobile device 400 to control the features of the system 100. For example, the software application can be used to remotely turn ON/OFF the system 100, increase or decrease the volume of a speaker, perform mode selection, turn ON/OFF the lights or otherwise adjust the same, or control any other components of the system 100. Further, the electronic device 400 is not limited to a smart phone and can also be any other type of electronic device such as a laptop, tablet or other media player.

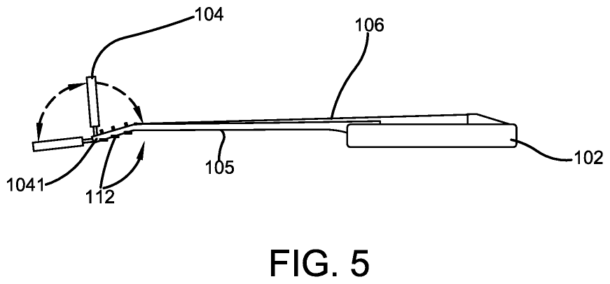

FIG. 5 illustrates a side perspective view of one potential embodiment of the combination musical instrument and karaoke system 100 of the present invention in accordance with the disclosed specification. The side perspective view shows that the dimensional view of the system 100. For example, in an embodiment of the present invention, the instrument 101 may be designed for adults and be approximately 40-42″ long, whereas an instrument 101 designed especially for a child may be much shorter and closer to 28-32″ long.

As shown, the neck 105 of the instrument 101 is an elongated member that is longer than, and extends outwardly from, the base 102. For example, the neck 105 of the instrument 101 for an adult may be 24-26″ long, and the base 102 may be 14-16″ long. Further, the base or housing 102 is wide enough to accommodate the karaoke system 103 and its various components to enable a user to use the instrument 101 in combination with the karaoke system 103. Nonetheless, the dimensions of the instrument 101 are not so limited, and the instrument 100 can have any other dimensions as per the wants and needs of the user.

Additionally, as stated above, the display screen 104 may be attached to the head 112 or neck 105 of the instrument 101 using a hinge 1041, wherein the screen 104 is rotatable about the hinge 1041 and its connection point to the head 112 or neck 105. In this manner, the display screen 104 can be rotated at any angle toward or away from the head 112 or neck 105 of the instrument 101 to provide a comfortable view of the content displayed on the screen 104 to the user 300 while performing. Additionally, the screen 104 can be rotated in a manner to enable the instrument 100 to be stored in less space.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “musical instrument”, “improved instrument”, “instrument with video screen” and “instrument with karaoke system” are interchangeable and refer to the system 100 of the present invention.

Notwithstanding the forgoing, the combination musical instrument and karaoke system 100 of the present invention can be of any suitable size and configuration as is known in the art without affecting the overall concept of the invention, provided that it accomplishes the above stated objectives. One of ordinary skill in the art will appreciate that the size, configuration and material of the combination musical instrument and karaoke system 100 as shown in the FIGS. are for illustrative purposes only, and that many other sizes and shapes of the combination musical instrument and karaoke system 100 are well within the scope of the present disclosure. Although the dimensions of the combination musical instrument and karaoke system 100 are important design parameters for user convenience, the combination musical instrument and karaoke system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An entertainment system comprising:
a musical instrument comprised of a housing, a neck and a head;
a karaoke system positioned at least partially within the housing; and
at least one speaker in communication with the karaoke system and the musical instrument, wherein the musical instrument has at least two operational modes.

2. The entertainment system as recited in claim 1, wherein the musical instrument is a stringed instrument.

3. The entertainment system as recited in claim 2, wherein the stringed instrument is selected from a group consisting of a guitar, a bass, a banjo, a lute, a ukulele, a mandolin, a violin, a cello and a fiddle.

4. The entertainment system as recited in claim 1, wherein the karaoke system comprises a visual display that is removable attached to a select one of the neck or the head.

5. The entertainment system as recited in claim 4, wherein the visual display displays one or more of a lyric, a name, a set of bibliographic information, a trivia and a plurality of string finger positions.

6. The entertainment system as recited in claim 1, wherein the karaoke system is in wireless communication with a smart device for downloading a plurality of songs for storage in the karaoke system.

7. The entertainment system as recited in claim 1, wherein the karaoke system comprises a memory, a controller, a processor and an amplifier.

8. The entertainment system as recited in claim 7, wherein the karaoke system further comprises a microphone.

9. The entertainment system as recited in claim 8, wherein the karaoke system further comprises a battery, a wireless communication module and a control panel.

10. The entertainment system as recited in claim 1 further comprising a plurality of lights positioned on the musical instrument.

11. The entertainment system as recited in claim 10, wherein the plurality of lights are synced with the karaoke system.

12. The entertainment system as recited in claim 1, wherein the at least two operational modes comprise a musical instrument sound emitting mode and a musical instrument non-sound emitting mode.

13. A stringed musical instrument comprising:
a housing;
a neck;
a head;
a plurality of strings; and
an entertainment system comprising a memory, a controller, a processor, a speaker, an amplifier and a display, wherein the memory comprises a plurality of songs and further wherein the display is mounted on a select one of the neck or the head and displays an information about a select one of the plurality of songs.

14. The stringed musical instrument as recited in claim 13, wherein the stringed musical instrument is selected from a group consisting of a guitar, a bass, a banjo, a lute, a ukulele, a mandolin, a violin, a cello and a fiddle.

15. The stringed musical instrument as recited in claim 13 further comprises a sound emitting mode and a non-sound emitting mode.

16. The stringed musical instrument as recited in claim 15, wherein in the non-sound emitting mode, movement of the plurality of strings does not produce an audible sound through the speaker.

17. The stringed musical instrument as recited in claim 16, wherein the entertainment system further comprises a battery, a wireless module, a microphone and a control panel.

18. The stringed musical instrument as recited in claim 13, wherein the information includes at least one of a lyric, a name, a bibliographic information, a trivia and a plurality of string finger positions.

19. A guitar and karaoke system combination comprising:
a guitar comprised of a plurality of strings, a neck, a head and a housing, wherein the guitar has a first mode of operation and a second mode of operation;
a karaoke system contained at least partially within the housing and comprising a controller, a processor, a memory, a microphone and an amplifier;
a display connected to the head of the guitar, wherein the display streams a set of information relating to a song and the set of information included at least one of a lyric, a name, a bibliographic information, a trivia and a plurality of string finger positions; and
a control panel disposed on an outer surface of the housing.

20. The guitar and karaoke system combination as recited in claim 19, wherein the first mode of operation involves emitting a sound through the speaker that is produced from a strumming of the plurality of strings, and the second mode does not involve emitting the sound through the speaker.
